(19) United States
(12) Patent Application Publication
(10) Pub. No.: US 2010/0189444 A1
(43) Pub. Date: Jul. 29, 2010

(54) OPTICAL MEMS DEVICE AND REMOTE SENSING SYSTEM UTILIZING THE SAME

(75) Inventors: David William Vernooy, Niskayuna, NY (US); Glen Peter Koste, Niskayuna, NY (US); Aaron Jay Knobloch, Mechanicville, NY (US); Faisal Razi Ahmad, Niskayuna, NY (US)

Correspondence Address: GENERAL ELECTRIC COMPANY;GLOBAL RESEARCH, ONE RESEARCH CIRCLE, BLDG. K1-3A59, NISKAYUNA, NY, 12309, US

(73) Assignee: GENERAL ELECTRIC COMPANY, SCHENECTADY, NY (US)

(21) Appl. No.: 12/608,328

(22) Filed: Oct. 29, 2009

Related U.S. Application Data
(63) Continuation-in-part of application No. 12/360,144, filed on Jan. 27, 2009.

(51) Int. Cl. H04B 10/12

(52) U.S. Cl. 398/141

(57) ABSTRACT

A remote sensing system comprises a micro-electromechanical sensor (MEMS) device comprising an optical energy absorbing sensing element that resonates by thermal expansion induced by absorption of optical signals, a remotely located optical source for transmitting driving optical signals to induce resonation in the sensing element, and a remotely located reader circuitry to read an original frequency of the sensing element using reader optical signals for determining a condition to which the MEMS device is exposed.

### CROSS-REFERENCE TO RELATED APPLICATION

This application is a continuation-in-part of co-owned and co-pending U.S. patent application Ser. No. 12/360,144 entitled “MEMS DEVICES AND REMOTE SENSING SYSTEMS UTILIZING THE SAME,” filed Jan. 27, 2009, which is herein incorporated by reference.

### BACKGROUND

The invention relates generally to sensing systems and, more particularly, to an optical micro-electromechanical sensor (MEMS) device and a remote sensing system using the optical MEMS device.

MEMS devices have applications in measurement of a variety of ambient conditions such as pressure and temperature. Mechanical characteristics of sensing elements in MEMS devices change depending on the ambient conditions that they are trying to measure. This change in mechanical characteristics influences the mechanical resonance of the device and this effect is used to measure the ambient condition. One type of MEMS device for measuring ambient conditions includes a sensing element integrated with electronics. The sensing element is generally a mechanical structure, and the electronics both cause the sensing element to vibrate and are used to measure the element's vibrational frequency. Changes in the vibrational frequency of the sensing element are used to measure ambient conditions, as it can be made proportional to these conditions using mechanical stress transduction.

The electronics in such MEMS devices are co-located with the sensing element. The main drawback with such MEMS devices is that typically the operating conditions of the MEMS devices are restricted to the operating conditions of the electronics. The sensing element itself can withstand broader ranges of temperature, pressure, or other harsh conditions, but the associated electronics pose limitations.

It would therefore be desirable to provide a MEMS device and a sensing system for remotely sensing pressure, current, temperature, or other measurable conditions, eliminating the need for having electronics in close proximity to the MEMS device.

### BRIEF DESCRIPTION

In accordance with one embodiment disclosed herein, a remote sensing system comprises a micro-electromechanical sensor (MEMS) device comprising an optical energy absorbing sensing element that resonates by thermal expansion induced by absorption of optical signals, a remotely located optical source for transmitting driving optical signals to induce resonation in the sensing element, and a remotely located reader circuitry to read an original frequency of the sensing element using reader optical signals for determining a condition to which the MEMS device is exposed.

In accordance with another embodiment disclosed herein, a remote sensing system comprises a micro-electromechanical sensor (MEMS) device, a remotely located optical source for transmitting driving optical signals to induce resonation in the sensing element, a remotely located reader circuitry to read an original frequency of the sensing element using reader optical signals for determining a condition to which the MEMS device is exposed, and an optical fiber network enabling transmission of the driving, reading and reflected optical signals. The MEMS device comprises of an optical energy absorbing sensing element that resonates by thermal expansion induced by absorption of optical signals and doped and un-doped portions to enable optical energy absorption. The reader circuitry comprises of a reader optical source for transmitting the reader optical signals and a photodiode detector for detecting optical signals reflected from the MEMS device.

In accordance with another embodiment disclosed herein, a remote sensing system comprises a micro-electromechanical sensor (MEMS) device, a remotely located optical source for transmitting driving optical signals to induce resonation in the sensing element, a remotely located reader circuitry to read an original frequency of the sensing element using reader optical signals for sensing a current to which the MEMS device is exposed, and an optical fiber network enabling transmission of the driving, reading and reflected optical signals. The MEMS device comprises an optical energy absorbing sensing element that resonates by thermal expansion induced by absorption of optical signals, doped and un-doped portions to enable optical energy absorption, and a magnetostrictive material associated with the sensing element. The reader circuitry comprises a reader optical source and a photodiode detector for detecting reflected optical signals.

### DRAWINGS

These and other features, aspects, and advantages of the present invention will become better understood when the following detailed description is read with reference to the accompanying drawings in which like characters represent like parts throughout the drawings, wherein:

FIG. 1 illustrates an embodiment of MEMS device in accordance with aspects disclosed herein.

FIG. 2 illustrates another embodiment of MEMS device in accordance with aspects disclosed herein.

FIG. 3 illustrates another embodiment of MEMS device in accordance with aspects disclosed herein.

FIG. 4 illustrates a current sensing embodiment of MEMS device in accordance with aspects disclosed herein.

FIG. 5 illustrates an embodiment of the remote sensing system in accordance with aspects disclosed herein.

FIG. 6 illustrates another embodiment of the remote sensing system in accordance with aspects disclosed herein.

### DETAILED DESCRIPTION

Embodiments disclosed herein include an optically powered micro-electromechanical sensor (MEMS) device and remote sensing system using the optically powered MEMS device. The sensing system is used to measure various conditions such as pressure, current, and temperature to which the MEMS device is exposed. The MEMS device is placed at or near a location where information about such conditions is needed. The sensing system includes an optical source to drive a sensing element of the MEMS device into resonance and a reader circuitry to acquire the frequency of the sensing element to determine the condition to which the MEMS device is exposed. As used herein, singular forms such as “a,” “an,” and “the” include plural referents unless the context clearly dictates otherwise.

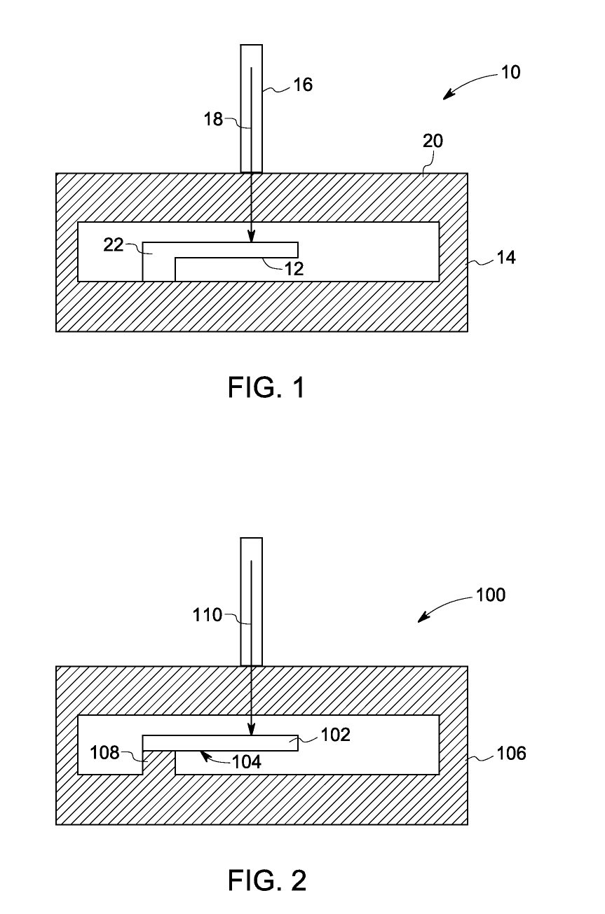

FIG. 1 illustrates an embodiment of the micro-electromechanical (MEMS) device 10. The MEMS device 10 includes an optical energy absorbing and thermally expanding resonating sensing element 12 and an enclosure 14 for the sensing element 12. The sensing element 12 is a mechanical resonating sensing element with high Q (quality factor). In one embodiment, the quality factor is greater than about 20,000 for accurate measurements.

The sensing element 12 thermally expands by absorbing optical energy delivered through an optical fiber 16 in the form of optical signals 18. The optical energy absorption generates heat, causing movement in the sensing element 12 via thermal expansion. The optical energy is delivered in a way to provide periodic thermal expansion in the sensing element 12. The pulsing frequency of the optical signals 18 is swept around the resonant frequency of the sensing element 12. The periodic thermal expansion vibrates the sensing element 12 and eventually induces resonation in the sensing element 12. The outer enclosure is non-absorptive in that it does not absorb optical signals that are at a wavelength of the driving light signal 18 and the sensing element is designed such that it absorbs optical signals at that same wavelength. Therefore, depending on the wavelength, the material of the sensing element can be doped, un-doped, silicon, or metal. Accordingly, the material for the enclosure can be chosen depending on the wavelength of the optical signals. For example, in one embodiment, the outer enclosure is made of un-doped silicon that is trasmittive (i.e. non-absorptive) in the infrared range and the sensing element is made of doped silicon that is absorptive of the same wavelength of light.

In one embodiment, the MEMS device 10 includes doped (absorptive) silicon portion 22 and un-doped (non-absorptive) 20 silicon portions for optimizing optical absorption. In one embodiment, the enclosure 14 is un-doped and the sensing element 12 is doped. Optical signals 18 delivered through the optical fiber pass through the un-doped enclosure 14 and arrive at doped sensing element 12. The sensing element 12 therefore absorbs the optical signals 18, thermally expands, and vibrates at resonant frequency.

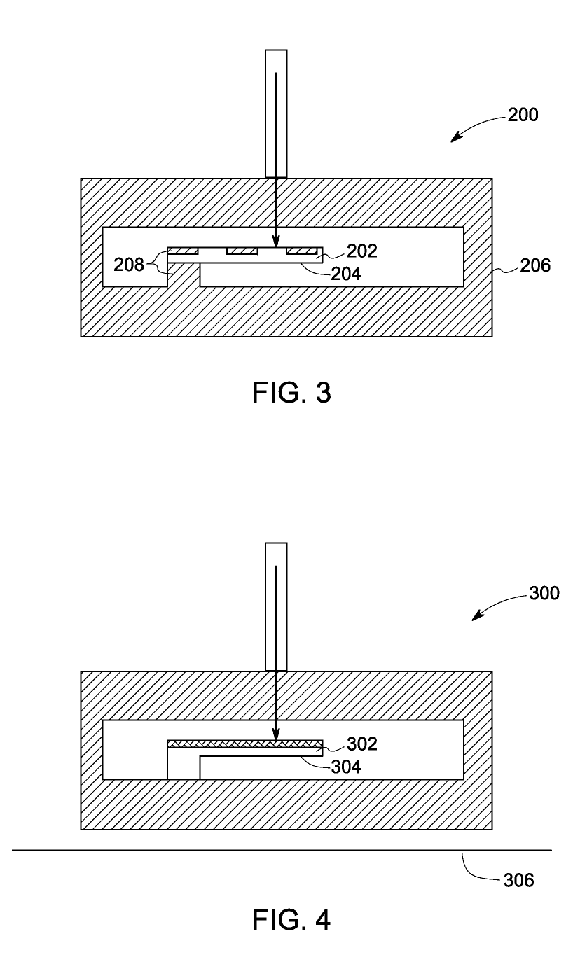

In another embodiment 100 as shown in FIG. 2, only a portion 102 of the sensing element 104 is doped and the rest of the MEMS device 100 including the enclosure 106 and part 108 of the sensing element 104 is un-doped. The doped portion 102, i.e. the absorptive portion, intercepts the driving optical signals 110. In another embodiment 200 as shown in FIG. 3, only a certain area 202 of the sensing element 204 can be doped to optimize optical absorption and resonating characteristics. The rest of the MEMS device 200 including the enclosure 206 and other parts 208 of the sensing element 204 are un-doped. The location of the doped or un-doped sections in the sensing element can be selected based on the shape of the sensing element and optimal optical absorption for resonation for that specific shape.

The MEMS device 10, 100, and 200 is used to measure various external conditions such as, but not limited to, pressure, temperature, and current. In order to determine an external condition, the MEMS device is exposed to such condition. The MEMS device is designed such that the external conditions change the resonant frequency of the sensing element. For example, for pressure sensing applications, a diaphragm (not shown) can be included in the MEMS device to couple external pressure to the sensing element 12, 104, and 204. The external pressure will change the resonant frequency of the sensing element. Similarly, for temperature sensing applications, the sensing element can be designed to experience stress due to external temperature, leading to change in the resonant frequency of the sensing element 12. This new frequency of the sensing element is compared to the original resonant frequency of the sensing element to determine the external pressure.

Referring to FIG. 4, for current sensing applications, the MEMS device 300 is provided with a layer of magnetostrictive material 302 in the sensing element 304. The MEMS device 300 is exposed to a current-carrying wire 306. The magnetostrictive layer 302 changes stress in response to a magnetic field. The current-carrying wire 306 produces a magnetic field, inducing stress in the magnetostrictive layer 302. This stress changes the resonant frequency of the sensing element 304. The change in frequency is detected and compared to resonant frequency of the sensing element 304 to determine current in the wire 306.

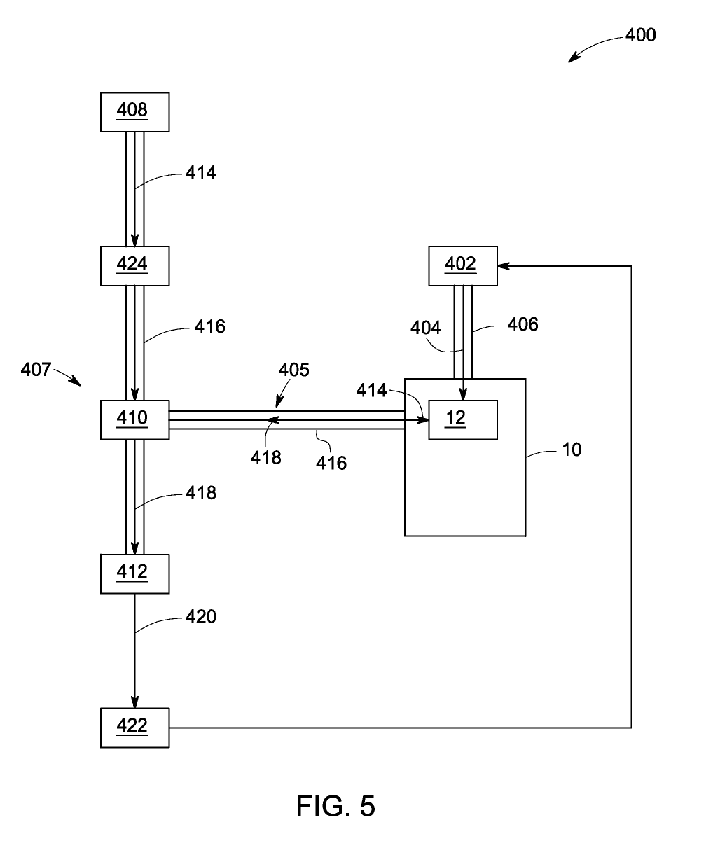

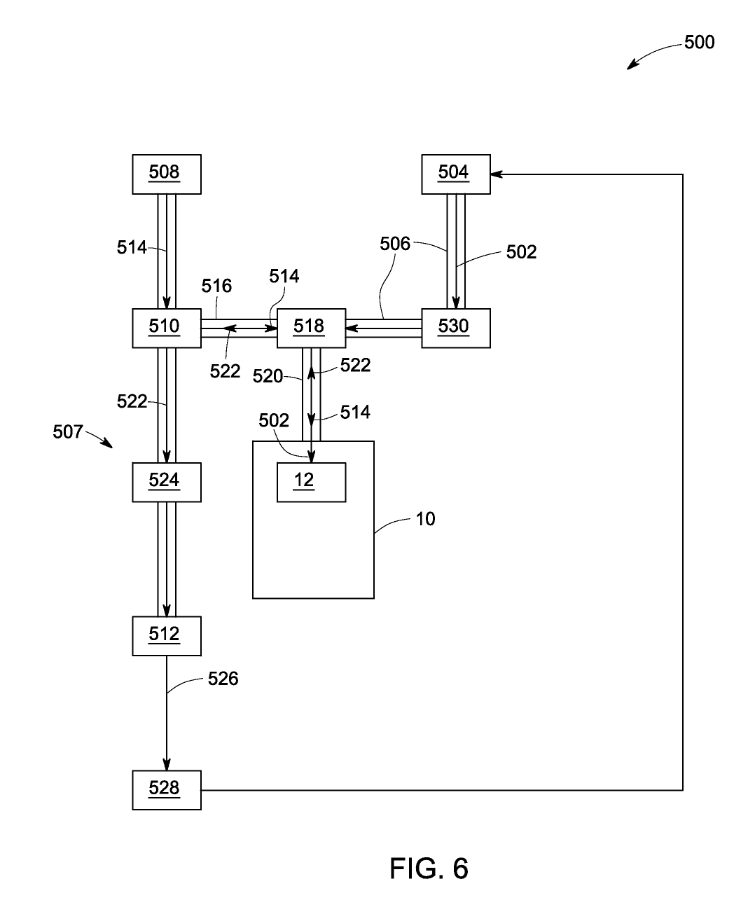

FIG. 5 illustrates an embodiment of the remote sensing system 400 that uses the MEMS device described previously in reference to FIGS. 1-4. The system includes a remotely located optical source 402 such as, for example, an LED, laser, or super-luminescent LED to generate a driving optical signal 404. In one embodiment, the optical signal resides in the infrared band. The wavelength of the optical signal 404 is selected such that it can pass through the un-doped portions of the enclosure. Other optical signals of various wavelengths, including visible wavelengths, can also be used.

The system further includes an optical fiber network 405. The driving optical signals 404 is transmitted to the MEMS device 10 via a first optical fiber 406 that can be a single-mode fiber or a multimode fiber. This signals 404 can be modulated at a frequency f₀, which may be swept around the resonant frequency of the sensing element 12. As described previously, the sensing element 12 absorbs the optical signals 404. The absorption generates heat and provides periodic thermal expansion in the sensing element 12. The periodic thermal expansion induces resonation in the sensing element 12. If the modulation frequency f₀ coincides with the resonant frequency fᵣ of the sensing element 12, then resonance is induced in the sensing element 12.

The system 400 further includes a remotely located reader circuitry 407 that includes a reader optical source 408, an optical splitter 410, and a photodiode detector 412. The reader optical source 408 can be an LED, laser, or super-luminescent LED to generate the reader optical signal 414. Optical power requirements for reader optical signal 414 and the driving optical signal 404 may vary. Driving optical power will determine how much motion is caused in the sensing element 12. Therefore, high power is required for remotely located optical source 402 that generates driving optical signals 404 to drive the sensing element 12 into resonance. A relatively low power source can be used for the reader optical source 408 since it is not used to resonate the sensing element.

The reader optical signal 414 is not modulated and is operated in continuous power mode. The reader optical signal 414 is transmitted to the MEMS device 10 through a second optical fiber 416, preferably a multimode optical fiber. The reader optical signal 414 enters the MEMS device 10 and reflects from the sensing element 12 that is being forced into resonance by the driving optical signal 404. The reflection of the signal from the moving sensing element 12 will cause interference with reflections from other parts of the MEMS device 10 that are not in motion. This interference can be detected as an AC component in the photocurrent of a detector. The reflected optical signal 418 includes information about interference and passes back through the optical splitter 410 to the photodiode detector 412. The detected signal 420 is then analyzed at the receiver 422 to determine original frequency of the sensing element 12. The original frequency of the sensing element 12 is then related to mechanical resonance of the sensing element 12 to determine an ambient condition to which the MEMS device is exposed.

In another embodiment, the sensing element 12 resonant frequency can be detected due to motion perpendicular to the reader signal 414, which modulates the reflection of the signal back into the fiber. In this embodiment, the sensing element 12 is intermittently in the path of the reader signal 414 and the frequency of the sensing element 12 coming into and out of the path is determined to be the resonant frequency of the structure.

Several options can be included to enhance the system performance, including the use of optical isolators 424 to isolate the sources from back-reflections, optical filters and various combinations of single mode and multimode fiber. The receiver 422 can be integrated with a swept oscillator source that is used to drive the first optical source 402.

In this embodiment, the driving optical signals enter the MEMS device via the first optical fiber 406 and the reader optical signals enter the MEMS device via the second optical fiber 416. This allows the same optical wavelength to be used for both driving and reading without the problem of crosstalk or interference. Also, this allows more flexibility in the placement of the reader location with respect to the drive location.

FIG. 6 illustrates another embodiment of the remote sensing system 500 using the optical approach, in which the driving optical signals and the reader optical signals enter the MEMS device via a single optical fiber. In this case, two different source wavelengths for interrogation and readout are needed to ensure there is no crosstalk or interference between the two light sources.

A modulated driver optical signal 502 generated by a remotely located optical source 504 is transmitted through a first optical fiber 506. The reader circuitry 507 includes a reader optical source 508, an optical splitter 510, and a photodiode detector 512. A reader optical signal 514 generated by the second optical source 508 is transmitted to the splitter 510 through a second optical fiber 516. The driver optical signal 502 on the first optical fiber 506 and the reader optical signal 514 at the output of the splitter 510 on a second optical fiber 516 are combined in a wavelength-division multiplexer 518 onto a single optical fiber 520 that is connected to the MEMS device 10. This last stretch of fiber 520 is preferably a multimode fiber.

The mechanisms for drive and readout are identical to that described previously in reference to FIG. 5, except that the reflected portion 522 of the read optical signal is separated from the reflected portion (not shown) of the drive optical signal in the wavelength-division multiplexer 518. This reflected signal 522 is sent back to the splitter 510 to a photodiode detector 512, where it is analyzed to determine the resonance frequency of the sensing element 12. The detected signal 526 is then analyzed at the receiver 528 to determine original frequency of the sensing element 12. The original frequency of the sensing element 12 is then related to mechanical resonance of the sensing element 12 to determine an ambient condition to which the MEMS device is exposed. In this case, the photodiode detector 512 further includes an optical bandpass filter 524 to ensure minimal contamination from the driving optical signal wavelength. Also, an optical isolator 530 can be used to isolate any sources from back-reflections.

In another system-level implementation, which can be used with the embodiments of FIGS. 5 and 6, it is possible to eliminate the need to sweep the modulation to search for the sensor resonance frequency. In this case, the output of the detection photodiode is amplified, phase shifted and then directly fed back to the modulation input of the driving optical source. With enough gain, the entire system will again oscillate, allowing auto-detection of the resonance frequency.

In another system-level implementation, the sensing element can be made to self-resonate, i.e. the driving optical signal need not be modulated. This can be achieved using positive feedback. As the sensing element gets heated due to optical absorption, it moves away from a neutral position. This will change the optical intensity at the sensing element. As long as this change decreases the intensity, the sensing element will stop absorbing and springs back to the neutral position. Then the cycle of moving away from neutral position and springing back to neutral position starts again. In this way, the device is essentially self-powered and finds its own resonant frequency rather than having to use a swept source to find the resonant frequency.

It should be noted that optical driving or optical reading in the above embodiments can replaced with other driving or reading embodiments such as induction drive/read, acoustic/drive, radio frequency drive/read, or acoustic drive/read described in co-owned and co-pending U.S. patent application Ser. No. 12/360,144 entitled “MEMS DEVICES AND REMOTE SENSING SYSTEMS UTILIZING THE SAME,” filed Jan. 27, 2009, which is herein incorporated by reference.

The remote sensing systems described above thus provide a way to remotely drive the MEMS device and remotely acquire frequency of the sensing element to measure external conditions to which the sensing element is exposed. The MEMS device and the sensing system enable remote sensing of pressure, temperature, current, or other condition in harsh environments while eliminating the need for wiring, batteries, active electronics, and physical access to the sensor. Absence of active electronics makes the MEMS device suitable for high temperature and pressure applications. The remote sensing system has applications in harsh temperature, pressure, chemical, and noise environments.

It is to be understood that not necessarily all such objects or advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A remote sensing system, comprising:
a micro-electromechanical sensor (MEMS) device comprising:
an optical energy absorbing sensing element that resonates by thermal expansion induced by absorption of optical signals;
a remotely located optical source for transmitting driving optical signals to induce resonation in the sensing element; and
a remotely located reader circuitry to read an original frequency of the sensing element using reader optical signals for determining a condition to which the MEMS device is exposed.

2. The system of claim 1, wherein the MEMS device comprises an absorptive portion and a non-absorptive portion to generate thermal expansion in the sensing element.

3. The system of claim 1, wherein the sensing element comprises absorptive and non-absorptive portions.

4. The system of claim 3, wherein the absorptive portion intercepts the driving optical signals.

5. The system of claim 2, wherein the MEMS device further comprises a non-absorptive enclosure for the sensing element.

6. The system of claim 1, wherein the sensing element further comprises a magnetostrictive material.

7. The system of claim 6, wherein the condition comprises current.

8. The system of claim 1, wherein the condition comprises pressure, temperature, gas composition or a combination thereof.

9. The system of claim 1, wherein the driving optical signals are swept for searching resonant frequency of the sensing element.

10. The system of claim 1, wherein the sensing element finds its resonant frequency.

11. The system of claim 1, further comprises signal-controlling elements such as a splitter, a mixer, a circulator, an isolator, or combinations thereof.

12. The system of claim 1, wherein the reader circuitry comprises a reader optical source for transmitting the reader optical signals and a photodiode detector for detecting optical signals reflected from the MEMS device.

13. The system of claim 12, wherein the optical source and the reader optical source comprise an LED, laser, or super-luminescent LED.

14. The system of claim 12, wherein the reader optical signal is an un-modulated optical signal.

15. The system of claim 12, wherein the system further comprises an optical fiber network connecting the optical source and the reader circuitry to the MEMS device.

16. The system of claim 15, wherein the driving optical signals and the reader optical signals enter the MEMS device via a single optical fiber.

17. The system of claim 15, wherein the driving optical signals enter the MEMS device via a first optical fiber and the reader optical signals enter the MEMS device via a second optical fiber.

18. A remote sensing system, comprising:
a micro-electromechanical sensor (MEMS) device comprising:
an optical energy absorbing sensing element that resonates by thermal expansion induced by absorption of optical signals; and
an absorptive portion and a non-absorptive portion to generate thermal expansion in the sensing element;
a remotely located optical source for transmitting driving optical signals to induce resonation in the sensing element;
a remotely located reader circuitry to read an original frequency of the sensing element using reader optical signals for determining a condition to which the MEMS device is exposed, wherein the reader circuitry comprises a reader optical source for transmitting the reader optical signals and a photodiode detector for detecting optical signals reflected from the MEMS device; and
an optical fiber network enabling transmission of the driving, reading and reflected optical signals.

19. The system of claim 18, wherein the sensing element comprises the absorptive portion and the non-absorptive portion.

20. The system of claim 18, wherein the sensing element further comprises a magnetostrictive material on the sensing element.

21. The system of claim 20, wherein the condition comprises current.

22. The system of claim 18, wherein the condition comprises pressure, temperature, gas composition or a combination thereof.

23. The system of claim 18, wherein the driving optical signals are swept for searching resonant frequency of the sensing element.

24. The system of claim 18, further comprises signal-controlling elements including a splitter, a mixer, a circulator, an isolator, or combinations thereof.

25. The system of claim 18, wherein the optical source and the reader optical source comprise an LED, laser, or super-luminescent LED.

26. A remote sensing system, comprising:
a micro-electromechanical sensor (MEMS) device comprising:
an optical energy absorbing sensing element that resonates by thermal expansion induced by absorption of optical signals;
a doped portion and an un-doped portion to enable optical energy absorption; and
a magnetostrictive material associated with the sensing element;
a remotely located optical source for transmitting driving optical signals to induce resonation in the sensing element;
a remotely located reader circuitry to read an original frequency of the sensing element using reader optical signals for sensing a current to which the MEMS device is exposed, the reader circuitry comprises a reader optical source and a photodiode detector for detecting reflected optical signals; and
an optical fiber network enabling transmission of the driving, reading and reflected optical signals.
